(19) United States
(12) Patent Application Publication
(10) Pub. No.: US 2024/0093696 A1
(43) Pub. Date: Mar. 21, 2024

(54) MIXED FLOW INLINE FAN ASSEMBLY

(71) Applicant: Johnson Controls Tyco IP Holdings LLP, Milwaukee, WI (US)

(72) Inventors: Digambar Satappa Killedar, Kolhapur (IN); Arshad Abdul Quader Shaikh, Aurangabad (IN); Juan Kennedy, Rockwall, TX (US); Ilya Igorevich Burdukov, Rockwall, TX (US); Suraj Vitthal Kumbhar, Pune (IN); Nikhil Vinayak Desai, Pune (IN)

(21) Appl. No.: 18/368,476

(22) Filed: Sep. 14, 2023

(30) Foreign Application Priority Data
Sep. 16, 2022 (IN) 202221052972

(51) Int. Cl. F04D 29/34; F04D 19/00; F04D 29/26; F04D 29/32; F04D 29/52; F04D 29/54

(52) U.S. Cl. CPC F04D 29/34; F04D 19/002; F04D 29/263; F04D 29/326; F04D 29/522; F04D 29/542

(57) ABSTRACT

A mixed flow inline fan assembly includes an outer housing, a motor assembly disposed within the outer housing, a fan wheel disposed within the outer housing, where a shaft of the motor assembly is coupled to the fan wheel, and the fan wheel includes a hub, a plurality of blades coupled to the hub via first mechanical fasteners, and a shroud coupled to the plurality of blades via second mechanical fasteners

### CROSS-REFERENCE TO RELATED APPLICATIONS

This application claims priority from and the benefit of India Provisional Patent Application No. 202221052972, entitled “A FAN ASSEMBLY,” filed Sep. 16, 2022, which is hereby incorporated by reference in its entirety for all purposes.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

The present disclosure relates generally to heating, ventilation, and/or air conditioning (HVAC) systems and, more particularly, to a fan for an HVAC system. A wide range of applications exist for HVAC systems. HVAC systems may be used to thermally regulate an environment, such as a space within a building, home, or other structure. The HVAC system may include a vapor compression system having heat exchangers, such as a condenser and an evaporator, which transfer thermal energy between the HVAC system and the environment. Accordingly, HVAC systems may be utilized to heat or cool a conditioned space. In some applications, an HVAC system may operate to dehumidify a conditioned space, ventilate air within a conditioned space, filter air supplied to a conditioned space, and so forth. Fans or other flow generating devices are frequently incorporated in HVAC systems to force or drive air flows in a desired direction or manner. For example, fans may be utilized to circulate air flow through the HVAC system, direct a flow of supply air into a conditioned space, direct a flow of return air from the conditioned space to the HVAC system, discharge a flow of exhaust air to an ambient environment, and so forth. Unfortunately, traditional fans in HVAC systems are susceptible to various shortcomings. For example, manufacture of existing fans may be time-consuming and/or expensive, and existing fans may be cumbersome to transport and difficult to install.

### SUMMARY

A summary of certain embodiments disclosed herein is set forth below. It should be noted that these aspects are presented merely to provide the reader with a brief summary of these certain embodiments and that these aspects are not intended to limit the scope of this disclosure. Indeed, this disclosure may encompass a variety of aspects that may not be set forth below

In one embodiment, a mixed flow inline fan assembly includes an outer housing, a motor assembly disposed within the outer housing, a fan wheel disposed within the outer housing, where a shaft of the motor assembly is coupled to the fan wheel, and the fan wheel includes a hub, a plurality of blades coupled to the hub via first mechanical fasteners, and a shroud coupled to the plurality of blades via second mechanical fasteners.

In another embodiment, a mixed flow inline fan assembly includes an outer housing, an inlet body coupled to the outer housing via first mechanical fasteners, where the inlet body is configured to direct an air flow into the outer housing, and where the inlet body is coupled to the outer housing via first mechanical fasteners, a motor disposed within the outer housing, where the motor includes a shaft, and a fan wheel disposed within the outer housing and coupled to the shaft. The fan wheel includes a hub, a plurality of blades coupled to the hub and extending radially outward from the hub, and a shroud coupled to the plurality of blades and extending circumferentially about the plurality of blades, where the hub, the plurality of blades, and the shroud are assembled together via second mechanical fasteners.

In a further embodiment, a mixed flow inline fan assembly includes an outer housing, an inlet body coupled to the outer housing, where the inlet body is configured to direct an air flow into the outer housing, a motor assembly disposed within the outer housing, where the motor assembly includes a motor housing and a motor disposed within the motor housing, and a fan wheel disposed within the outer housing and coupled to the motor, where the fan wheel includes a hub, a plurality of blades coupled to the hub, and a shroud coupled to the plurality of blades and extending circumferentially about the plurality of blades, and where the outer housing, the inlet body, the motor assembly, the hub, the plurality of blades, and the shroud are coupled to one another via mechanical fasteners.

### BRIEF DESCRIPTION OF THE DRAWINGS

Various aspects of this disclosure may be better understood upon reading the following detailed description and upon reference to the drawings in which:

FIG. 1 is a perspective view of an embodiment of a building incorporating a heating, ventilation, and air conditioning (HVAC) system in a commercial setting, in accordance with an aspect of the present disclosure;

FIG. 2 is a schematic of an embodiment of an airside system of an HVAC system, in accordance with an aspect of the present disclosure;

FIG. 3 is a perspective view of an embodiment of a mixed flow inline fan assembly, in accordance with an aspect of the present disclosure;

FIG. 4 is a perspective view of a portion of an embodiment of a mixed flow inline fan assembly, in accordance with an aspect of the present disclosure;

FIG. 5 is a perspective view of a portion of an embodiment of a mixed flow inline fan assembly, in accordance with an aspect of the present disclosure;

FIG. 6 is a perspective view of a portion of an embodiment of a mixed flow inline fan assembly, in accordance with an aspect of the present disclosure; and

FIG. 7 is a cross-sectional perspective view of an embodiment of mixed flow inline fan assembly, in accordance with an aspect of the present disclosure.

### DETAILED DESCRIPTION

One or more specific embodiments of the present disclosure will be described below. These described embodiments are examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “approximately,” “generally,” and “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to mean that the property value may be within +/−5%, within +/−4%, within +/−3%, within +/−2%, within +/−1%, or even closer, of the given value. Similarly, when a given feature is described as being “substantially parallel” to another feature, “generally perpendicular” to another feature, and so forth, this is intended to mean that the given feature is within +/−5%, within +/−4%, within +/−3%, within +/−2%, within +/−1%, or even closer, to having the described nature, such as being parallel to another feature, being perpendicular to another feature, and so forth. Further, it should be understood that mathematical terms, such as “planar,” “slope,” “perpendicular,” “parallel,” and so forth are intended to encompass features of surfaces or elements as understood to one of ordinary skill in the relevant art, and should not be rigidly interpreted as might be understood in the mathematical arts. For example, a “planar” surface is intended to encompass a surface that is machined, molded, or otherwise formed to be substantially flat or smooth (within related tolerances) using techniques and tools available to one of ordinary skill in the art. Similarly, a surface having a “slope” is intended to encompass a surface that is machined, molded, or otherwise formed to be oriented at an angle (e.g., incline) with respect to a point of reference using techniques and tools available to one of ordinary skill in the art.

As briefly mentioned above, the present disclosure is directed toward heating, ventilation, and air conditioning (HVAC) systems and, more particularly, toward a fan assembly for an HVAC system. Specifically, present embodiments are directed to a fan assembly including various components that are assembled together via mechanical fasteners, such as rivets, screws, nuts and bolts, or other fasteners, instead of a fabrication process, such as welding. Fans may be incorporated in an HVAC system to drive an air flow in a desired direction or manner. For example, fans may be utilized to direct an air flow across a heat exchanger, across a filter, out of the HVAC system (e.g., HVAC unit, air handler), into the HVAC system, toward a conditioned space, through a conditioned space, out of a conditioned space, and so forth. In some embodiments, the fan is an inline fan, such as a mixed flow inline fan. For example, a mixed flow inline fan may be positioned within a conduit (e.g., ductwork) or housing and may be configured to direct an air flow through and/or along the conduit or housing. Indeed, mixed flow inline fans may be utilized in HVAC systems to direct supply air into a space, direct return air out of the space, and/or discharge exhaust air from the space, such as in ventilation applications. As will be appreciated, mixed flow inline fans may also direct an air flow at elevated air flow rates and/or elevates pressure with enhanced efficiency and reduced vibration and sound output. Unfortunately, traditional fans, such as traditional mixed flow inline fans, are expensive and time-consuming to manufacture. For example, traditional fans may be manufactured using fabrication processes, such as welding, to assemble components of the traditional fans. As a result, traditional fans may be formed from thick and/or heavy materials (e.g., heavy gauge sheet metal) suitable for welding, which also increases an overall weight of the traditional fans. Thus, traditional fans are also cumbersome to transport, install, and maintain.

It is now recognized that more cost-effective and time-efficient manufacturing of fan assemblies (e.g., mixed flow inline fan assemblies) is desired. Accordingly, embodiments of the present disclosure are directed to a fan assembly, such as a mixed flow inline fan assembly, that includes various components that are assembled together with mechanical fasteners, such as nuts and bolts, rivets, screws, and so forth. Indeed, a substantial number of the components of the fan assembly may be assembled to one another via mechanical fasteners. In other words, a large number (e.g., a majority) of the components of the fan assembly may not be assembled to one another via welding or other time consuming and expensive fabrication process. As a result, present embodiments provide a fan assembly that may be manufactured more quickly and at a reduced cost. In addition to enabling a reduction in manufacturing (e.g., labor) costs, present embodiments also enable a reduction in material costs associated with manufacture of the fan assembly. For example, utilization of mechanical fasteners to assemble a substantial portion of the components of the fan assembly enables the use of more lightweight and cost-effective materials for the components of the fan assembly. That is, while traditional fan assemblies are assembled via extensive welding or other fusing fabrication processes and utilize materials (e.g., thick sheet metal) that are suitable for undergoing a welding process, present embodiments enable the utilization of more lightweight (e.g., thinner) materials to manufacture components of the fan assembly, such as higher gauge sheet metal, as compared to traditional fan assemblies. Accordingly, the fan assemblies disclosed herein may be transported and installed with greater ease and efficiency. Embodiments of the fan assembly disclosed herein may also implemented in various applications with increased versatility. For example, fan assemblies incorporating the present techniques may be manufactured with a reduced size (e.g., footprint) and may be installed at sites or in locations with limited available space. The present techniques are described in further detail below.

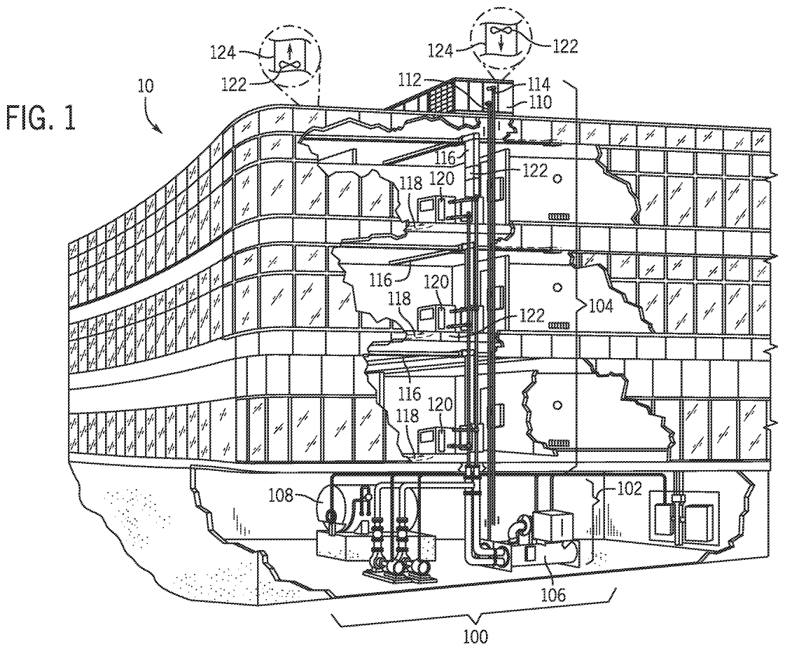

Turning now to the drawings, FIG. 1 illustrates an embodiment of a heating, ventilation, and air conditioning (HVAC) system for building environmental management that may employ a fan. As used herein, an HVAC system includes any number of components configured to enable regulation of parameters related to climate characteristics, such as temperature, humidity, air flow, pressure, air quality, and so forth. For example, an “HVAC system” as used herein is defined as conventionally understood and as further described herein. Components or parts of an “HVAC system” may include, but are not limited to, all, some of, or individual parts such as a heat exchanger, a heater, an air flow control device, such as a fan, a sensor configured to detect a climate characteristic or operating parameter, a filter, a control device configured to regulate operation of an HVAC system component, a component configured to enable regulation of climate characteristics, or a combination thereof. An “HVAC system” is a system configured to provide such functions as heating, cooling, ventilation, dehumidification, pressurization, refrigeration, filtration, or any combination thereof. The embodiments described herein may be utilized in a variety of applications to control climate characteristics, such as residential, commercial, industrial, transportation, or other applications where climate control is desired.

In the illustrated embodiment, a building 10 is serviced by a heating, ventilation, and air conditioning (HVAC) system 100 that may include a plurality of HVAC devices and/or other HVAC equipment (e.g., heaters, chillers, air handling units, pumps, fans, thermal energy storage units, etc.) configured to provide heating, cooling, air conditioning, ventilation, and/or other services for the building 10. For example, the HVAC system 100 is shown to include a waterside system 102 and an airside system 104. The waterside system 102 may generate and provide a heated fluid and/or a chilled fluid to equipment of the airside system 104, and the airside system 104 may utilize the heated fluid and/or the chilled fluid to heat or cool an air flow provided to the building 10. However, it should be appreciated that the techniques disclosed herein may be incorporated with other embodiments of the HVAC system 100, such as a direct expansion system.

The HVAC system 100 may include a chiller 106, a boiler 108, and an air handling unit (AHU) 110 (e.g., a rooftop unit). The waterside system 102 may utilize the chiller 106 or the boiler 108 to cool or heat, respectively, a conditioning fluid (e.g., water, glycol, etc.) and may circulate the conditioning fluid to the AHU 110. In various embodiments, components of the waterside system 102, such as the chiller 106 and/or the boiler 108, may be located in or around the building 10 or at an offsite location such as a central plant (e.g., a chiller plant, a steam plant, a heat plant, etc.) that serves one or more portions of the building 10. The conditioning fluid may be heated in the boiler 108 or cooled in the chiller 106, depending on whether heating or cooling is desired in the building 10. The boiler 108 may add heat to the circulated conditioning fluid, for example, by burning a combustible material (e.g., natural gas) or using an electric heating element to transfer heat to the conditioning fluid. The chiller 106 may place the circulated conditioning fluid in a heat exchange relationship with a working fluid (e.g., a refrigerant) in a heat exchanger (e.g., an evaporator) to absorb heat from the conditioning fluid. The conditioning fluid from the chiller 106 and/or the boiler 108 may be directed to the AHU 110 via piping 112 (e.g., fluid conduits, supply piping).

The AHU 110 may place the conditioning fluid in a heat exchange relationship with an air flow directed through the AHU 110 (e.g., via one or more stages of cooling coils and/or heating coils). The air flow may be, for example, outside air, return air from within the building 10, or a combination of both. The AHU 110 may transfer heat between the air flow and the conditioning fluid to heat and/or cool the air flow. For example, the AHU 110 may include one or more fans or blowers configured to direct the air flow across or through a heat exchanger configured to circulate the conditioning fluid. The conditioning fluid may then be directed back to the chiller 106 and/or the boiler 108 via piping 114 (e.g., fluid conduits, return piping).

The airside system 104 may deliver the air flow supplied by the AHU 110 (e.g., a supply air flow) to the building 10 via air supply ducts 116 (e.g., ductwork) and may direct return air from the building 10 to the AHU 110 via air return ducts 118 (e.g., ductwork). In some embodiments, the airside system 104 includes one or more variable air volume (VAV) units 120. For example, in the illustrated embodiment, the airside system 104 include separate VAV units 120 positioned within or otherwise associated with each floor or zone of the building 10. The VAV units 120 may include dampers or other flow control elements that are operable to control an amount of the supply air flow provided to individual zones of the building 10. In other embodiments, the airside system 104 is configured to deliver the supply air flow to one or more zones of the building 10 (e.g., via the air supply ducts 116) without utilizing the VAV units 120 or other flow control elements. The AHU 110 may include various sensors (e.g., temperature sensors, pressure sensors, etc.) configured to detect and/or measure attributes of the supply air flow or other operating parameters of the HVAC system 100. The AHU 110 may receive input (e.g., feedback, data) from sensors located within the AHU 110 and/or within the building 10 and may adjust the flow rate, temperature, or other attributes of the supply air flow through the AHU 110 to achieve set point conditions for the building 10.

In some embodiments, the HVAC system 100 may incorporate one or more fans 122, such as a mixed flow inline fan. For example, one of the fans 122 may be a component of the AHU 110. In such an embodiment, the fan 122 may be configured to direct an air flow across a heat exchanger, filter, or other component of the AHU 110, into the AHU 110, out of the AHU 110 and into the air supply ducts 116, out of the air return ducts 118 and into the AHU 110, into an ambient environment surrounding the AHU 110, or any combination thereof. For example, the fan 122 may be a mixed flow inline fan that is installed inline (e.g., along, serially with) one of the air supply ducts 116 or one of the air return ducts 118. In some embodiments, the fan 122 may be a component separate from the AHU 110. For example, the building 10 may be a warehouse, industrial building, data center, computer server building, or other large structure, and the fan 122 may be utilized to enable circulation or ventilation of air into and/or out of the building 10. The fan 122 (e.g., mixed flow inline fan) may be a ventilation or supply air fan configured to direct fresh air from an ambient environment into the building 10 via an inlet duct of the building 10. In some embodiments, the fan 122 (e.g., mixed flow inline fan) may be an exhaust fan configured to direct air from within the building 10 to the ambient environment surrounding the building 10 (e.g., as exhaust air) via an exhaust duct of the building 10.

As mentioned above, the fan 122 may be an inline fan, such as a mixed flow inline fan, configured to be positioned within a housing or conduit 124 (e.g., a tube). Accordingly, the fan 122 may be configured to direct an air flow through the conduit 124 (e.g., duct), and the fan 122 may be configured to impart axial and radial forces onto the air flow (e.g., to induce a swirl flow) directed through the conduit 124. In this way, the fan 122 may be configured to direct the air flow at elevated pressures and/or flow rates with increased efficiency. However, it should be appreciated that the presently disclosed techniques may be incorporated within any suitable fan 122 utilized to direct an air flow in a desired direction or manner. It should be appreciated that any of the features described herein may be incorporated with the building 10 (e.g., ductwork of the building), the AHU 110, a residential heating and cooling system, or other HVAC systems. For example, the features described herein may be applied to mechanical cooling systems, free cooling systems, chiller systems, direct expansion systems, and/or other heat pump or refrigeration applications.

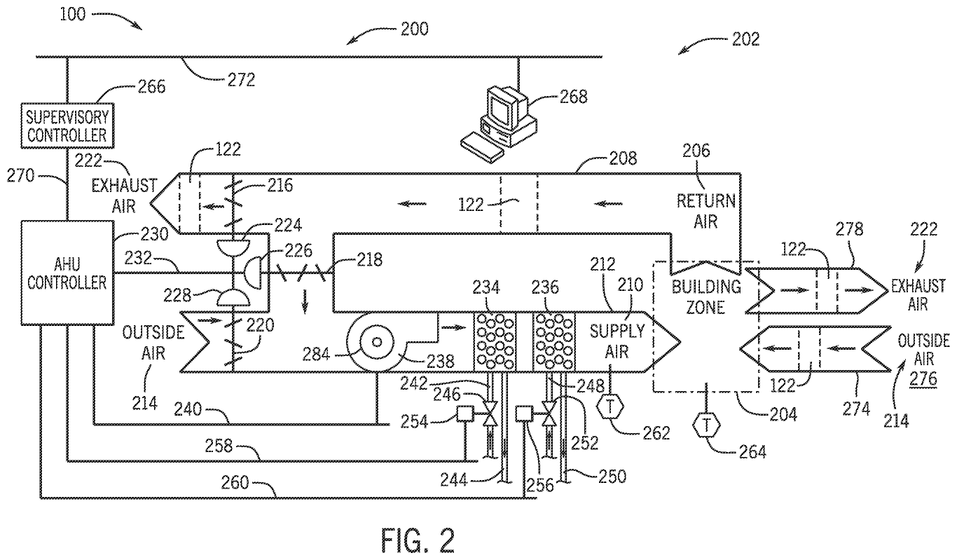

FIG. 2 is a schematic of an embodiment of the HVAC system 100 including an airside system 200, such as an embodiment of the airside system 104. The airside system 200 may include one or more of the HVAC devices and/or equipment discussed above, such as the AHU 110, the VAV units 120, the ducts 116, 118, fans, dampers, and so forth. Accordingly, one or more components of the HVAC system 100 may be located in or around the building 10. The airside system 200 may operate to heat or cool an air flow provided to the building 10 using a heated or chilled fluid provided by the waterside system 102.

In the illustrated embodiment of FIG. 2, the airside system 200 includes include an economizer-type air handling unit (AHU) 202 (e.g., HVAC unit). The economizer-type AHU 202 may vary respective amounts of outside air and return air used by the AHU 202 for heating or cooling a building zone 204 (e.g., conditioned space). For example, the AHU 202 may receive return air 206 from the building zone 204 via return air duct 208 (e.g., of the building 10) and may deliver supply air 210 to the building zone 204 via a supply air duct 212 (e.g., of the building 10). In some embodiments, the AHU 202 (e.g., the AHU 110) is a rooftop unit located on the roof of the building 10 or otherwise positioned and/or configured to receive both the return air 206 and outside air 214 from an environment surrounding the HVAC system 100 and/or building zone 204. The AHU 202 may be configured to operate an exhaust air damper 216, a mixing damper 218, and an outside air damper 220 to control an amount of the outside air 214 and the return air 206 that is combined to form the supply air 210. Return air 206 that does not flow through the mixing damper 218 may be exhausted from the AHU 202 through the exhaust damper 216 as exhaust air 222.

Each of dampers 216, 218, 220 may be operated by an actuator. For example, the exhaust air damper 216 may be operated by an actuator 224, the mixing damper 218 may be operated by an actuator 226, and the outside air damper 220 may be operated by an actuator 228. The actuators 224, 226, 228 may communicate with an AHU controller 230 via a communications link 232. The actuators 224, 226, 228 may receive control signals from the AHU controller 230 and may provide feedback signals to the AHU controller 230. Feedback signals may include, for example, an indication of a current (e.g., detected, measured) actuator or damper position, an amount of torque or force exerted by the actuator 224, 226, 228, diagnostic information (e.g., results of diagnostic tests performed by actuators 224, 226, 228), status information, commissioning information, configuration settings, calibration data, and/or other types of information or data that may be collected, stored, or used by the actuators 224, 226, 228. The AHU controller 230 may be an economizer controller configured to execute one or more control algorithms (e.g., state-based algorithms, extremum seeking control [ESC] algorithms, proportional-integral [PI] control algorithms, proportional-integral-derivative [PID] control algorithms, model predictive control [MPC] algorithms, feedback control algorithms, etc.) to control the actuators 224, 226, 228.

The AHU 202 further includes a cooling coil 234 (e.g., heat exchanger), a heating coil 236 (e.g., heat exchanger), and a fan 238 (e.g., fan 122) positioned within the supply air duct 212. The fan 238 may be configured to force the supply air 210 across the cooling coil 234 and/or the heating coil 236 and provide the supply air 210 to the building zone 204. The AHU controller 230 may communicate with the fan 238 via a communications link 240 to control a flow rate of the supply air 210 (e.g., through the supply air duct 212, into the building zone 204). In some embodiments, the AHU controller 230 is configured to control an amount of heating or cooling applied to the supply air 210 by modulating a speed of the fan 238.

The cooling coil 234 may receive a chilled fluid from the waterside system 102 (e.g., the chiller 106), such as via piping 242, and may return the chilled fluid to the waterside system 102 via piping 244. A valve 246 may be positioned along the piping 242 and/or the piping 244 to control a flow rate of the chilled fluid through cooling coil 234. In some embodiments, the cooling coil 234 includes multiple stages of cooling coils that may be independently activated and deactivated (e.g., by the AHU controller 230, by a supervisory controller 266, etc.) to modulate an amount of cooling applied to the supply air 210.

The heating coil 236 may receive a heated fluid from the waterside system 102 (e.g., the boiler 108) via piping 248 and may return the heated fluid to the waterside system 102 via piping 250. A valve 252 may be positioned along the piping 248 and/or the piping 250 to control a flow rate of the heated fluid through the heating coil 236. In some embodiments, the heating coil 236 includes multiple stages of heating coils that may be independently activated and deactivated (e.g., by the AHU controller 230, by the supervisory controller 266, etc.) to modulate an amount of heating applied to the supply air 210.

Each of the valves 246 and 252 may be controlled by a respective actuator. For example, the valve 246 may be controlled by an actuator 254, and the valve 252 may be controlled by an actuator 256. The actuators 254, 256 may communicate with the AHU controller 230 via communications links 258, 260. The actuators 254, 256 may receive control signals from the AHU controller 230 and may provide feedback signals to the AHU controller 230. In some embodiments, the AHU controller 230 may receive a measurement (e.g., data) of the temperature of the supply air 210 from a temperature sensor 262 positioned within the supply air duct 212 (e.g., downstream of the cooling coil 234 and/or the heating coil 236). The AHU controller 230 may also receive a measurement (e.g., data) of a temperature in the building zone 204 from a temperature sensor 264 located within the building zone 204.

In some embodiments, the AHU controller 230 is configured to operate the valves 246 and 252 via the actuators 254, 256 to modulate an amount of heating or cooling provided to the supply air 210 (e.g., to achieve a set point temperature for the supply air 210 and/or to maintain a temperature of the supply air 210 within a set point temperature range). The positions of the valves 246 and 252 may affect an amount of heating or cooling provided to the supply air 210 by the cooling coil 234 or the heating coil 236, respectively, by controlling a flow rate of the chilled fluid or heated fluid, respectively, therethrough. The AHU controller 230 may control a temperature of the supply air 210 and/or a temperature within the building zone 204 by activating or deactivating the coils 234, 236, adjusting a speed of the fan 238, or both.

As mentioned above, the airside system 200 may include the supervisory controller 266, which may be communicatively coupled to a client device 268. The supervisory controller 266 may include one or more computer systems (e.g., servers, supervisory controllers, subsystem controllers, etc.) that serve as system level controllers, application or data servers, head nodes, or master controllers for the airside system 200, the waterside system 102, the HVAC system 100, and/or other controllable systems that serve the building 10. The supervisory controller 266 may communicate with multiple downstream building systems or subsystems (e.g., the HVAC system 100, a security system, a lighting system, the waterside system 102, etc.) via a communications link 270 according to like or disparate protocols (e.g., LON, BACnet, etc.). In various embodiments, the AHU controller 230 and the supervisory controller 266 may be separate or integrated. In an integrated implementation, the AHU controller 230 may be a software module configured for execution by a processor of the supervisory controller 266.

In some embodiments, the AHU controller 230 is configured to receive information from the supervisory controller 266 (e.g., commands, set points, operating boundaries, etc.) and provide information to the supervisory controller 266 (e.g., temperature measurements, valve and/or actuator positions, operating statuses, diagnostics, etc.). For example, the AHU controller 230 may provide the supervisory controller 266 with temperature measurements from the temperature sensors 262, 264, equipment on/off states, equipment operating capacities, and/or any other information that may be used by the supervisory controller 266 to monitor or control a variable state or condition within the building zone 204.

The client device 268 may include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with the HVAC system 100 and the subsystems and/or devices thereof. The client device 268 may be a computer workstation, a client terminal, a remote or local interface, or any other type of user interface device. In some embodiments, the client device 268 may be a stationary terminal or a mobile device. For example, the client device 268 may be a desktop computer, a computer server with a user interface, a laptop computer, a tablet, a smartphone, and/or any other type of mobile or non-mobile device. The client device 268 may communicate with the supervisory controller 266 and/or the AHU controller 230 via a communications link 272.

In accordance with embodiments of the present disclosure, the airside system 200 may also include one or more embodiments of the fan 122 (e.g., a mixed flow inline fan). For example, in some embodiments, the fan 122 may be disposed within the supply air duct 212 extending from the AHU 202 to the building zone 204 and may be configured to control a flow of the supply air 210 directed into the building zone 204. Additionally or alternatively, the fan 122 may be disposed along the return air duct 208 and be configured to direct the return air 206 from the building zone 204 to the AHU 202. An embodiment of the fan 122 may be disposed at an end of the return air duct 208 and may be configured to discharge the exhaust air 222 from the AHU 202.

In some embodiments, the HVAC system 100 may include one or more fans 122 configured to direct outside air 214 (e.g., fresh air) into the building zone 204 without first directing the outside air 214 through the AHU 202. For example, the HVAC system 100 may include a fresh air conduit 274 fluidly coupling (e.g., directly fluidly coupling) the building zone 204 to an ambient environment 276 (e.g., outdoor environment) surrounding or otherwise external to the building zone 204 (e.g., the building 10). The fan 122 (e.g., mixed flow inline fan) may be disposed within the fresh air conduit 274 and may be configured to force a flow of the outside air 214 directly into the building zone 204, for example, to provide ventilation of the building zone 204. Similarly, the HVAC system 100 may additionally or alternatively include an exhaust air conduit 278 fluidly coupling (e.g., directly fluidly coupling) the building zone 204 to the ambient environment 276 surrounding the building zone 204. An embodiment of the fan 122 (e.g., mixed flow inline fan) may be disposed within the exhaust air conduit 278 and may be configured to discharge a flow of the exhaust air 222 from the building zone 204 directly to the ambient environment 276, for example, to provide ventilation of the building zone 204.

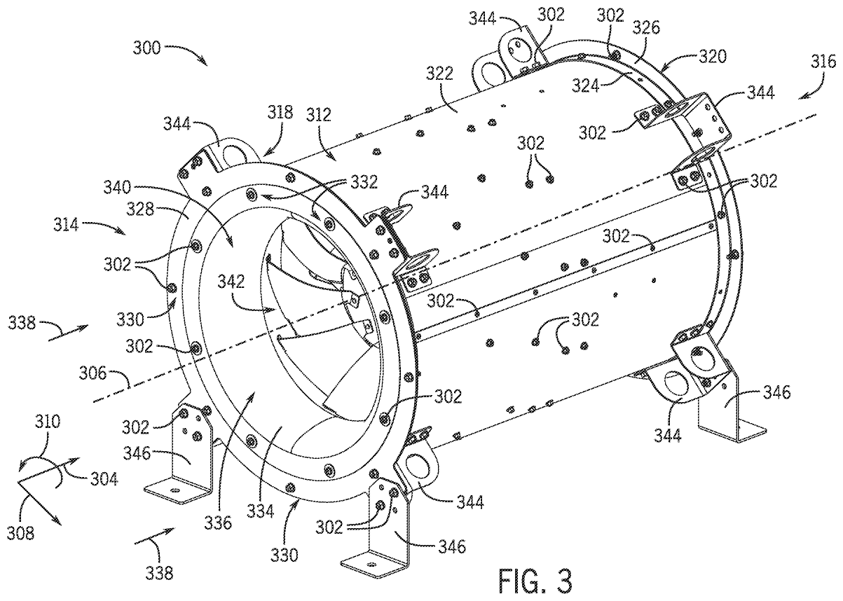

FIG. 3 is a perspective view of an embodiment of a fan assembly 300, in accordance with present techniques. The fan assembly 300 may be implemented as an embodiment of the fan 122 discussed above in any suitable application in which air flow is desired. For example, the fan assembly 300 may be implemented to direct a flow of supply air, return air, exhaust air, or any other suitable flow of air.

In the illustrated embodiment, the fan assembly 300 is configured as a mixed flow inline fan, which may be implemented to direct an air flow at elevated pressures and/or air flow rates with increased efficiency. Additionally, in accordance with present techniques, the fan assembly 300 includes multiple components that are assembled (e.g., removably coupled) together utilizing mechanical fasteners 302, such as nuts and bolts, rivets, screws, anchors, nails, washers, another suitable mechanical fastener, or any combination thereof. In particular, multiple components of the fan assembly 300 discussed below may be assembled together via mechanical fasteners 302 instead of via welding, brazing, or other time-consuming and expensive fabrication processes traditionally utilized to assemble and manufacture fan assemblies. In this way, the fan assembly 300 may be manufactured more quickly and at reduced costs (e.g., reduced labor costs, reduced material costs). Additionally, components of the fan assembly 300 secured and/or attached to one another via mechanical fasteners 302 may be removably coupled with one another to enable improved repair, replacement, and maintenance on components of the fan assembly 300.

As discussed herein, multiple groups, pluralities, sets, and/or subsets of mechanical fasteners 302 may be utilized to assemble components of the fan assembly 300. For example, each component (e.g., part, group of parts, type of part, etc.) discussed below that is coupled to another component (e.g., part, group of parts, type of part, etc.) of the fan assembly 300 may be described and/or considered to be coupled via a particular group, plurality, set, and/or subset of mechanical fasteners 302 (e.g., first mechanical fasteners, second mechanical fasteners, additional mechanical fasteners, first subset of mechanical fasteners, second subset of mechanical fasteners, and so forth). It should be appreciated that the different groups, pluralities, sets, and/or subsets of mechanical fasteners 302 may include a common type of mechanical fasteners 302 or may include different types of mechanical fasteners 302.

Further, the components of the fan assembly 300 that are assembled via mechanical fasteners 302 may be formed from any suitable material (e.g., metal), such as sheet metal. The material from which the components of the fan assembly 300 are formed may be thinner (e.g., higher gauge) than material typically used to form other fan assemblies, such as other mixed flow inline fans, because the components are not intended to withstand a process to couple the components to one another. Thus, the fan assemblies 300 disclosed herein may be manufactured at a reduced cost and may have a reduced overall weight compared to traditional mixed flow inline fans. In some embodiments, one or more components of the fan assembly 300 may be formed from a material (e.g., sheet metal) having a thickness of approximately 0.05 to 0.15 inches, 0.06 to 0.14 inches, 0.07 to 0.13 inches, 0.08 to 0.12 inches, 0.09 to 0.11 inches, or 0.1 inches. For clarity, the following discussion may include reference to an axial direction or axis 304 of the fan assembly 300 (e.g., along a central axis or rotational axis 306 of the fan assembly 300), a radial direction or axis 308 (e.g., relative to the central axis 306) of the fan assembly 300, and a circumferential direction 310 of the fan assembly 300.

As shown in the illustrated embodiment, the fan assembly 300 includes an outer housing 312 (e.g., outer drum, outer sleeve, main body, enclosure) that generally defines a first end 314 (e.g., upstream end) and a second end 316 (e.g., downstream end) of the fan assembly 300. In some embodiments, the outer housing 312 of the fan assembly 300 may be formed from a single piece of material (e.g., sheet metal, metal having a thickness of approximately 0.1 to 0.11 inches) that is bent, folded, rolled, or otherwise manipulated to form the generally cylindrical geometry of the outer housing 312. For example, edges of the outer housing 312 may be mechanically fastened to one another via mechanical fasteners 302 (e.g., rivets) to form and maintain the shape or configuration of the outer housing 312. In other embodiments, the outer housing 312 may be formed from multiple pieces of material secured to one another via mechanical fasteners 302.

As described in further detail below, the fan assembly 300 also includes a first mounting ring 318 (e.g., mounting band, support band, first outer mounting ring) coupled to the outer housing 312 at the first end 314 of the outer housing 312 and a second mounting ring 320 (e.g., mounting band, support band, second outer mounting) coupled to the outer housing 312 at the second end 316 of the outer housing 312. The first mounting ring 318 and the second mounting ring 320 may each extend about the outer housing 312 in the circumferential direction 310 and may be secured to an outer surface 322 of the outer body 312. In some embodiments, the first mounting ring 318 and the second mounting ring 320 may also be formed from sheet metal having a thickness of approximately 0.1 to 0.11 inches. In accordance with present techniques, the first mounting ring 318 and the second mounting ring 320 may be secured to the outer housing 312 via mechanical fasteners 302 (e.g., rivets, nuts and bolts). In some embodiments, the first mounting ring 318 and/or the second mounting ring 320 may have a generally L-shaped cross-sectional geometry. For example, in the illustrated embodiment, the second mounting ring 320 includes a first portion 324 (e.g., first mounting portion, first flange) and a second portion 326 (e.g., second mounting portion, second flange) that extend cross-wise relative to one another to form an L-shaped cross-sectional geometry. The first portion 324 may be secured to the outer housing 312 (e.g., the outer surface 322) via mechanical fasteners 302. The second portion 326 may extend from the first portion 324 in the radial direction 308 (e.g., radially outward relative to the central axis 306) and may extend about the central axis 306 in the circumferential direction 310. In this way, the second portion 326 may function as a mounting surface to which other components of the fan assembly 300 may be secured, such as via mechanical fasteners 302.

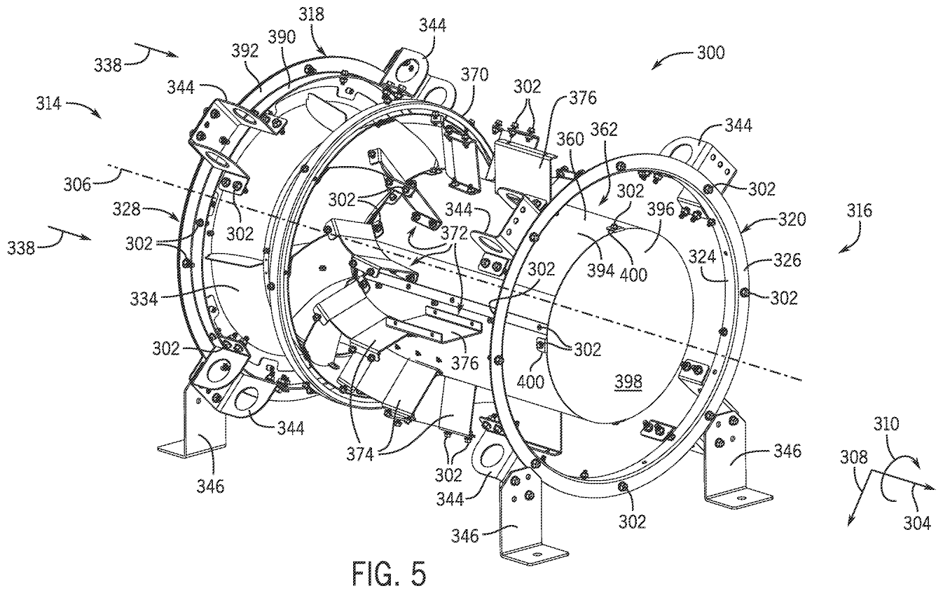

As shown and described in more detail below with reference to FIG. 5, the first mounting ring 318 may have a similar geometry and configuration as the second mounting ring 320. That is, the first mounting ring 318 may include a first portion secured to the outer housing 312 (e.g., the outer surface 322) via mechanical fasteners 302 at the first end 314 of the outer housing 312 and a second portion extending cross-wise from the first portion (e.g., in the radial direction 308 and circumferential direction 310) to form an L-shaped cross-sectional geometry. The second portion of the first mounting ring 318 may also function as a mounting surface to which other components of the fan assembly 300 may be secured. For example, in the illustrated embodiment, the fan assembly 300 includes an inlet body mounting ring 328 (e.g., inlet body mounting plate, mounting panel, venturi mounting ring, venturi mounting flange) that is fastened to the second portion of the first mounting ring 318 via mechanical fasteners 302. In particular, the inlet body mounting ring 328 includes a first arrangement (e.g., plurality) of apertures 330 formed therein and extending about the inlet body mounting ring 328 in the circumferential direction 310, and corresponding mechanical fasteners 302 extend through the first arrangement of apertures 330 and the second portion of the first mounting ring 318 to secure the inlet body mounting ring 328 to the first mounting ring 318. The inlet body mounting ring 328 may also be formed from any suitable material, such as sheet metal (e.g., having a thickness of approximately 0.1 to 0.11 inches).

The inlet body mounting ring 328 also includes a second arrangement (e.g., plurality) of apertures 332 formed therein and extending about the inlet body mounting ring 328 in the circumferential direction 310. The second arrangement of apertures 332 is arranged radially inward, relative to the central axis 306, from the first arrangement of apertures 330. The second arrangement of apertures 332 is configured to enable securement of an inlet body 334 of the fan assembly 300 to the inlet body mounting ring 328, such as via mechanical fasteners 302. In the illustrated assembled configuration of the fan assembly 300, at least a portion of the inlet body mounting ring 328 extends about the inlet body 334 in the circumferential direction 310. Further, at least a portion of the inlet body 334 may extend, in the axial direction 304 and/or into the outer housing 312, through an opening defined by the inlet body mounting ring 328.

As shown, the inlet body 334 defines an inlet 336 (e.g., opening, aperture, air flow inlet) of the fan assembly 300. That is, the fan assembly 300 is configured to receive an air flow 338 via the inlet 336 defined by the inlet body 334. The inlet body 334 may also be formed from any suitable material, such as sheet metal. In some embodiments, the inlet body 334 is formed from sheet metal having a thickness less than certain components discussed above (e.g., approximately 0.05 inches). Further, the inlet body 334 may have any suitable geometry or configuration. For example, the inlet body 334 may have an inlet surface 340 that extends about the central axis 306 in the circumferential direction 310 and defines a variable diameter of the inlet body 334 that varies in the axial direction 304. Specifically, the inlet surface 340 may define a venturi surface or venturi tube that facilitates and/or improves flow of the air flow 338 into the fan assembly 300. As described in further detail below, the air flow 338 may flow through the inlet 336 and along the inlet surface 340 (e.g., venturi surface) toward a fan wheel 342 disposed within the outer housing 312.

In the illustrated embodiment, the fan assembly 300 includes additional features that are assembled via mechanical fasteners 302. For example, the fan assembly 300 includes lifting lugs 344 secured to the outer housing 312 (e.g., outer surface 322) via mechanical fasteners 302. The lifting lugs 344 may be formed from any suitable material, such as sheet metal, and may have a thickness of approximately 0.1 to 0.11 inches, in some embodiments. Moreover, the lifting lugs 344 may be arrayed about the outer housing 312 in the circumferential direction 310 at the first end 314 and/or at the second end 316 of the outer housing 312. However, it should be appreciated that the lifting lugs 344 may be secured to the outer housing 312 in other arrangements. Additionally or alternatively, the lifting lugs 344 may be fastened (e.g., secured) to the first mounting ring 318 and the second mounting ring 320 (e.g., the second portion 326) via mechanical fasteners 302, as shown. As will be appreciated, the lifting lugs 344 are configured to enable lifting and repositioning of the fan assembly 300, such as during installation of the fan assembly 300 (e.g., via a crane, hoist, tether, etc.).

The illustrated embodiment of the fan assembly 300 also includes base supports 346 (e.g., support legs, support feet, braces) secured to the fan assembly 300 via mechanical fasteners 302. The base supports 346 are configured to support the fan assembly 300 in an installed configuration. To this end, the base supports 346 may be formed from a suitable material, such as sheet metal, having a thickness that is greater than that of certain components discussed above to withstand a weight of the fan assembly 300 in the installed configuration. For example, the base supports 346 may be formed from a material having a thickness of approximately 0.25 inches. Each base support 346 may be secured to one of the lifting lugs 344, to the inlet body mounting ring 328, to the first mounting ring 318 and/or the second mounting ring 320, or any combination thereof. Further, as shown, each base support 346 may be assembled to one or more of such components via a respective plurality of mechanical fasteners 302. In some embodiments, the base supports 346 may be configured to enable a suspended installation of the fan assembly 300. For example, the fan assembly 300 may be hung from a ceiling or other support structure via the base supports 346 in certain installed configurations of the fan assembly 300.

The illustrated embodiment further shows additional mechanical fasteners 302 extending through the outer housing 312 of the fan assembly 300 at various locations along and about the outer housing 312. As discussed in further detail below, mechanical fasteners 302 may extend through the outer housing 312 to assembly and secure additional components of the fan assembly 300 disposed internal to the outer housing 312.

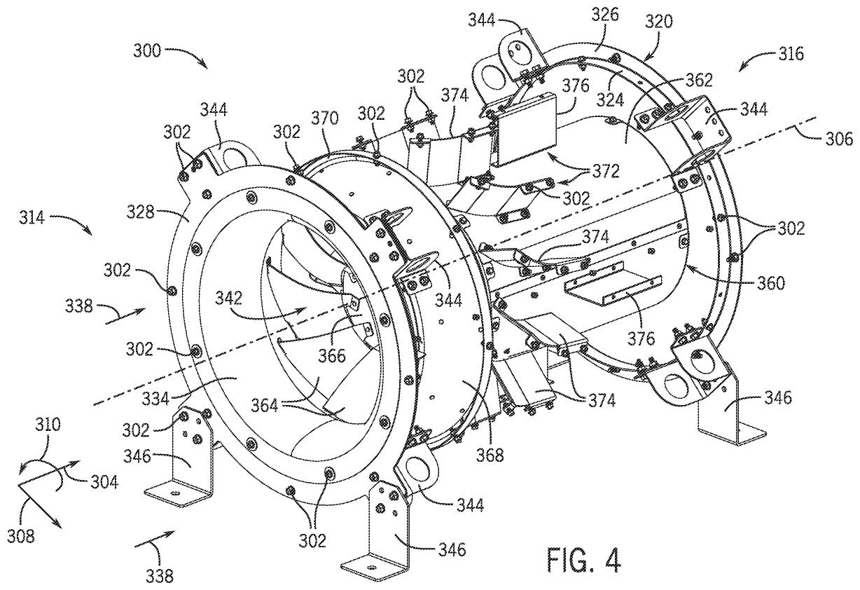

FIG. 4 is a perspective view of a portion of an embodiment of the fan assembly 300, illustrating components of the fan assembly 300 assembled with one another via mechanical fasteners 302. In the illustrated embodiment, the outer housing 312 is omitted to better illustrated components of the fan assembly 300 disposed internal to the outer housing 312 in an assembled configuration of the fan assembly 300. Certain elements and element numbers are similar to those discussed above with reference to FIG. 3.

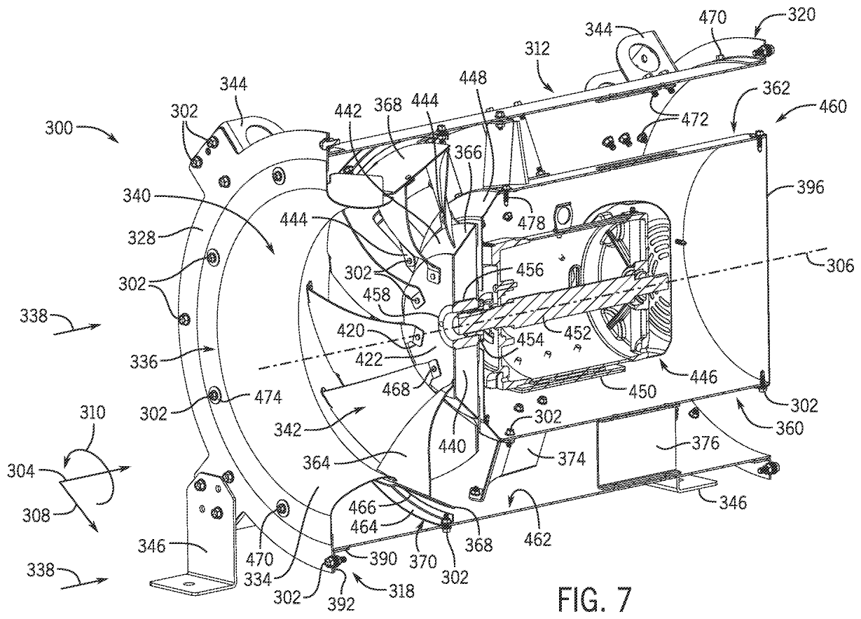

In addition to the fan wheel 342, the fan assembly 300 includes a motor assembly 360 that is disposed within the outer housing 312 in an assembled configuration of the fan assembly 300. That is, the outer housing 312 may enclose or contain the motor assembly 360 therein. As shown, the motor assembly 360 includes a motor housing 362 (e.g., enclosure) configured to enclose and contain a motor of the motor assembly 360, as shown and described in further detail below with reference to FIG. 7. The motor assembly 360 is configured to drive rotation of the fan wheel 342 of the fan assembly 300 to draw the air flow 338 into the fan assembly 300.

The fan wheel 342 includes a plurality of blades 364 coupled to a hub 366 (e.g., wheel hub, hub cone). The plurality of blades 364 may be assembled (e.g., secured, removably coupled) to the hub 366 via mechanical fasteners 302, as discussed in further detail below. The fan wheel 342 also includes a shroud 368 extending about the plurality of blades 364 in the circumferential direction 310. That is, the shroud 368 is disposed radially outward (e.g., along the radial direction 308, relative to the central axis 306) from the plurality of blades 364. In some embodiments, the shroud 368 may be formed from sheet metal. Further, the shroud 368 may have any suitable geometry, configuration, contour, or other shape configured to enable desired flow of the air flow 338 through the fan assembly 300. The plurality of blades 364 may also be assembled (e.g., secured, removably coupled) to the shroud 368 via mechanical fasteners 302. The fan wheel 342 is fastened to the motor of the motor assembly 360, such that rotation of a shaft of the motor drives rotation of the fan wheel 342 (e.g., in the circumferential direction 310), including the hub 366, the plurality of blades 364, and the shroud 368, within the fan assembly 300 (e.g., within the outer housing 312).

The fan assembly 300 includes additional components that may be disposed within the outer housing 312 and may be assembled with the fan assembly 300 utilizing mechanical fasteners 302. For example, the fan assembly 300 may include a baffle 370 that may be attached (e.g., removably coupled) to the outer housing 312 (e.g., an inner surface of the outer housing 312) via mechanical fasteners 302. The baffle 370 may be formed from sheet metal or other suitable material, and the material may have a thickness of approximately 0.06 to 0.07 inches. In an assembled configuration, the baffle 370 may be disposed at least partially at a common location along the central axis 306 of the fan assembly 300. Further, the baffle 370 may at least partially overlap with the shroud 368 in the radial direction 308. In other words, the baffle 370 may be disposed in an annular space or region extending radially (e.g., in the radial direction 308) between the shroud 368 and the outer housing 312 in the assembled configuration of the fan assembly 300. Additionally or alternatively, the baffle 370 may be disposed radially outward from the shroud 368 and may be at least partially disposed downstream of the shroud 368 (e.g., relative to a direction of the air flow 338 through the fan assembly 300, in the axial direction 304). In any case, the baffle 370 may be configured to reduce, mitigate, and/or block recirculation of the air flow 338 within the outer housing 312. In other words, the baffle 370 may be configured to facilitate and promote desired flow of the air flow 338 through the fan assembly 300 (e.g., through the outer housing 312).

The fan assembly 300 may also include a plurality of guide vanes 372 configured to facilitate and promote desired flow of the air flow 338 through the fan assembly 300. In the illustrated embodiment, the plurality of guide vanes 372 includes first guide vanes 374 (e.g., upstream guide vanes, first arrangement of guide vanes) and second guide vanes 376 (e.g., downstream guide vanes, second arrangement of guide vanes). The first guide vanes 374 are arranged upstream of the second guide vanes 376 relative to a direction of the air flow 338 through the fan assembly 300 (e.g., in the axial direction 304). The first guide vanes 374 may be arranged or arrayed about the motor housing 362 in the circumferential direction 310 at a first axial location along the central axis 306, and the second guide vanes 376 may be arranged or arrayed about the motor housing 362 in the circumferential direction 310 at a second axial location along the central axis 306 that is downstream of the first axial location. In some embodiments, one or more of the first guide vanes 374 may be offset from one another along the central axis 306 and/or one or more of the second guide vanes 376 may be offset from one another along the central axis 306. In the illustrated embodiment, each guide vane 372 extends generally radially outward from the motor housing 362 toward the outer housing 312 of the fan assembly 300. Additionally, as discussed further below, each guide vane 372 may be secured to the motor housing 362 and/or to the outer housing 312 of the fan assembly 300 via mechanical fasteners 302. In some embodiments, the guide vanes 372 may be mechanical attached to the motor housing 362 and to the outer housing 312 via mechanical fasteners 302 to add structural rigidity and/or strength to the fan assembly 300.

The guide vanes 372 may be formed from any suitable material (e.g., sheet metal) and may have any suitable thickness, such as 0.1 to 0.11 inches. The guide vanes 372 may also have any suitable geometry and may be formed via any suitable process, such as stamping, bending, forming, and so forth. For example, in the illustrated embodiment, each first guide vane 374 (e.g., upstream guide vane) has a curved or curvilinear geometry, such that each first guide vane 374 is contoured to extend at least partially along the central axis 306 and at least partially in the circumferential direction 310. In particular, each first guide vane 374 is curved in the circumferential direction 310 and in an upstream direction, relative to a direction of the air flow 338 through the fan assembly 300. Each second guide vane 376 (e.g., downstream guide vane) has a generally flat or linear geometry, such that each second guide vane 376 is contoured to extend substantially along the central axis 306. However, it should be appreciated that other embodiments may include guide vanes 372 having other geometries or configurations. Further, the illustrated embodiment includes a first number of the first guide vanes 374 and a second number of the second guide vanes 376, where the first number is greater than the second number. However, other embodiments of the fan assembly 300 may include a common number of the first guide vanes 374 and the second guide vanes 376 or a greater number of second guide vanes 376 than first guide vanes 374.

FIG. 5 is a perspective view of a portion of an embodiment of the fan assembly 300, illustrating components of the fan assembly 300 assembled with one another via mechanical fasteners 302. In the illustrated embodiment, the outer housing 312 is omitted to better illustrated components of the fan assembly 300 disposed internal to the outer housing 312 in an assembled configuration of the fan assembly 300. Certain elements and element numbers are similar to those discussed above with reference to FIG. 4.

The illustrated embodiment also of the fan assembly 300 also includes the first mounting ring 318. As mentioned above, the first mounting ring 318 includes a first portion 390 (e.g., first mounting portion, first flange) and a second portion 392 (e.g., second mounting portion, second flange) that extend cross-wise relative to one another to form an L-shaped cross-sectional geometry. The first portion 390 may be secured to the outer housing 312 (e.g., the outer surface 322) via mechanical fasteners 302. The second portion 392 may extend from the first portion 390 in the radial direction 308 (e.g., radially outward relative to the central axis 306) and may extend about the central axis 306 the circumferential direction 310. In this way, the second portion 392 may function as a mounting surface to which other components of the fan assembly 300 may be secured, such as via mechanical fasteners 302. Specifically, as discussed above, the inlet body mounting ring 328 may be attached (e.g., removably coupled) to the second portion 392 of the first mounting ring 318 via mechanical fasteners 302 extending through the first arrangement of apertures 330 formed in the inlet body mounting ring 328 and through corresponding apertures formed in the second portion 392 of the first mounting ring 318 to secure the inlet body mounting ring 328 to the first mounting ring 318.

The illustrated embodiment also includes the motor assembly 360 including the motor housing 362. The motor housing 362 includes a main body 394 (e.g., sleeve) having a generally cylindrical shape or geometry configured to receive a motor of the motor assembly 360. The main body 394 of the motor housing 362 may be formed from any suitable material, such as sheet metal. In some embodiments, the main body 394 is formed from sheet metal having a thickness of approximately 0.1 to 0.11 inches. For example, the main body 394 may be formed from a single piece of sheet metal that is bent, rolled, or otherwise formed to define the generally cylindrical shape of the main body 394, and edges of the piece of sheet metal may be fastened to one another via mechanical fasteners 302 (e.g., rivets) to maintain the generally cylindrical shape of the main body 394.

The motor housing 362 also includes a back cover 396 (e.g., rear cover, cover plate) that is removably coupled to the main body 394 via mechanical fasteners 302. In particular, the back cover 396 includes a main portion 398 having generally circular geometry that matches or corresponds to a cross-sectional shape of the main body 394. The back cover 396 also includes a plurality of tabs 400 extending from the main portion 398. In an assembled configuration of the motor housing 362, the plurality of tabs 400 may extend along and overlap with the main body 394 of the motor housing 362 (e.g., along the central axis 306, in the circumferential direction 310). Accordingly, mechanical fasteners 302 may extend through corresponding apertures formed in the tabs 400 and the main body 394 to enable securement of the back cover 396 to the main body 394. As desired, the mechanical fasteners 302 may be removed to readily enable removal of the back cover 396 from the main body 394 to expose the motor within the motor housing 362 for maintenance, removal, replacement, and/or other procedures. Similar to the components discussed above, the back cover 396 may also be formed from any suitable material, such as sheet metal, and the material of the back cover 396 may have any suitable thickness, such as approximately 0.06 to 0.07 inches (e.g., less than a thickness of the material of the main body 394).

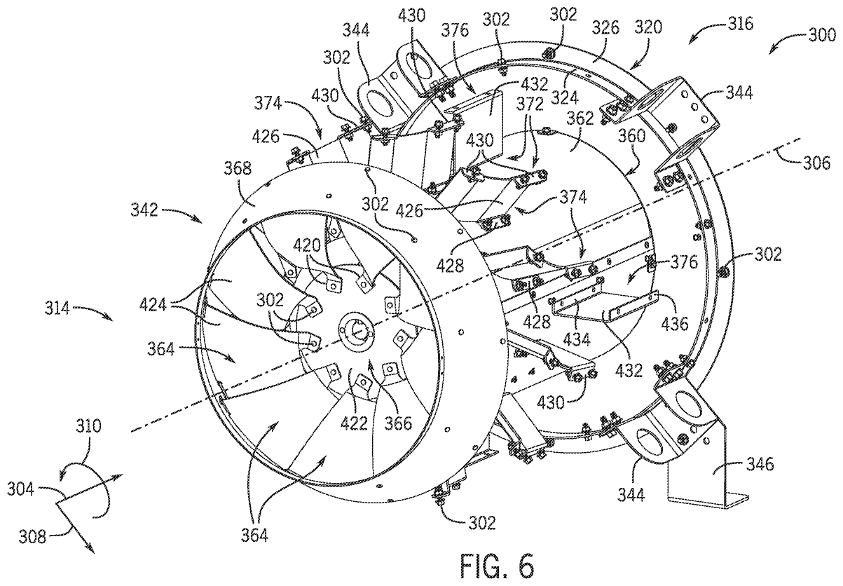

FIG. 6 is a perspective view of a portion of an embodiment of the fan assembly 300, illustrating components of the fan assembly 300 assembled with one another via mechanical fasteners 302. Certain elements and element numbers of the illustrated embodiment are similar to those discussed above with reference to FIG. 4. For example, the illustrating embodiment includes the fan wheel 342 having the hub 366, the plurality of blades 364, and the shroud 368.

As mentioned above, the plurality of blades 364 may be fastened to the hub 366 via mechanical fasteners 302. For example, in the illustrated embodiment, each blade 364 includes a first mounting tab 420 (e.g., radially inward mounting tab) fastened to the hub 366, such as to a blade mounting surface 422 (e.g., front portion, upstream portion, forward disk) of the hub 366. Each first mounting tab 420 may be attached to the blade mounting surface 422 of the hub 366 via a corresponding one of the mechanical fasteners 302 (e.g., via a corresponding rivet) extending through the first mounting tab 420 and the blade mounting surface 422. The blade mounting surface 422 may be a generally circular and/or planar surface of the hub 366 (e.g., extending radially outward and in the circumferential direction 310 relative to the central axis 306) to which each blade 364 may be attached via the respective first mounting tab 420. Thus, each blade 364 may be attached to the hub 366 at a generally common axial location along the central axis 306. In some embodiments, each blade 364 may include one or more additional first mounting tabs (e.g., radially inward mounting tab) configured to enable mechanical securement of the blade 364 to another portion of the hub 366, as discussed further below.

Each blade 364 also includes a blade surface 424 extending radially outward (e.g., relative to the central axis 306) and/or in the circumferential direction 310 from the hub 366. The blade surface 424 may have any suitable contour or geometry configured to enable desired flow of the air flow 338 through the fan assembly 300. As mentioned above, the fan assembly 300 may be a mixed flow inline fan. In such embodiments, the blade surface 424 of each blade 364 may be configured to impart axial and radial forces onto the air flow 338 to enable efficient flow of the air flow 338 through the fan assembly 300 at elevated flow rates and/or pressures. For each blade 364, the blade surface 424 extends radially outward from the first mounting tab 420 to one or more second mounting tabs (e.g., radially outward mounting tab) of the blade 364. The one or more second mounting tabs of the blade 364 are configured to enable fastening of the blade 364 to the shroud 368 via corresponding mechanical fasteners 302, such as rivets.

The illustrated embodiment also includes the guide vanes 372. Specifically, the fan assembly 300 includes the first guide vanes 374 and the second guide vanes 376 discussed above. Each first guide vane 374 includes a guide surface 426 (e.g., first guide surface), one or more first mounting flanges 428, and one or more second mounting flanges 430. The guide surface 426 of the first guide vanes 374 are at least partially curved, as discussed above, to facilitate and promote more efficient flow of the air flow 338 through the fan assembly 300. The one or more first mounting flanges 428 are configured to enable fastening of the first guide vane 374 to the motor housing 362 of the motor assembly 360. To this end, each first mounting flange 428 extends generally cross-wise to the guide surface 426 and may include one or more apertures configured to receive corresponding mechanical fasteners 302 therethrough. The mechanical fasteners 302 (e.g., nuts and bolts) may extend through the one or more first mounting flanges 428 and the motor housing 362 to mechanically attach the first guide vane 374 to the motor assembly 360. Similarly, each second mounting flange 430 extends generally cross-wise to the guide surface 426 and may include one or more apertures configured to receive corresponding mechanical fasteners 302 therethrough. The mechanical fasteners 302 (e.g., nuts and bolts) may extend through the one or more second mounting flanges 430 and the outer housing 312 to mechanically attach the first guide vane 374 to the outer housing 312. In this way, each first guide vane 374 may extend radially between and be mechanically attached to the motor assembly 360 and the outer housing 312 of the fan assembly 300.

Each second guide vane 376 includes a guide surface 432 (e.g., second guide surface), a first mounting flange 434, and a second mounting flange 436. In some embodiments, the guide surface 432, the first mounting flange 434, and the second mounting flange 436 may define a generally C-shaped cross-section or geometry. The guide surface 432 of the second guide vanes 376 are generally linear and/or planar (e.g., flat, straight), as discussed above, to facilitate and promote more efficient flow of the air flow 338 through the fan assembly 300. The first mounting flange 434 is configured to enable fastening of the second guide vane 376 to the motor housing 362 of the motor assembly 360. To this end, the first mounting flange 434 extends generally cross-wise to the guide surface 432 and may include one or more apertures configured to receive corresponding mechanical fasteners 302 therethrough. The mechanical fasteners 302 (e.g., nuts and bolts) may extend through the first mounting flange 434 and the motor housing 362 to mechanically attach the second guide vane 376 to the motor assembly 360. Similarly, the second mounting flange 436 extends generally cross-wise to the guide surface 432 and may include one or more apertures configured to receive corresponding mechanical fasteners 302 therethrough. The mechanical fasteners 302 (e.g., nuts and bolts) may extend through the second mounting flange 436 and the outer housing 312 to mechanically attach the second guide vane 376 to the outer housing 312. In this way, each second guide vane 374 may extend radially between and be mechanically attached to the motor assembly 360 and the outer housing 312 of the fan assembly 300.

FIG. 7 is a cross-sectional perspective view of an embodiment of the fan assembly 300, illustrating the fan assembly 300 in an assembled configuration with mechanical fasteners 302 implemented to assemble various components of the fan assembly 300 to one another. The illustrated embodiment includes elements and element numbers similar to those described above.

The illustrated embodiment also shows additional features of the fan assembly 300. For example, in addition to the blade mounting surface 422, the hub 366 also includes a hub base plate 440 and a hub transition portion 442 (e.g., cone portion, tapered portion) extending from the hub base plate 440 to the blade mounting surface 422. The blade mounting surface 422, the hub base plate 440, and the hub transition portion 442 define a generally conical frustum geometry of the hub 366. In certain embodiments, the blade mounting surface 422, the hub base plate 440, and the hub transition portion 442 may not be assembled utilizing mechanical fasteners 302. Instead, the blade mounting surface 422, the hub base plate 440, and the hub transition portion 442 may be fixed to one another utilizing welding or other fabrication process. In this way, the hub 366 may be configured to withstand forces acting on the hub 366 (e.g., torsional forces imparted by the motor assembly 360) during operation of the fan assembly 300.

As mentioned above, each blade 364 may include one or more additional first mounting tabs 444 configured to mechanical attach to the hub 366. For example, the additional first mounting tab 444 of each blade 364 may be configured to be attached to the hub base plate 440 via one of the mechanical fasteners 302 (e.g., a rivet), as similarly described above. Thus, the first mounting tab 420 and the additional first mounting tab 444 of each blade 364 may be offset from one another along the central axis 306, which may facilitate a twisted, sculpted or contoured geometry of the blade surface 424 to configure the blades 364 for operation in a mixed flow inline fan embodiment of the fan assembly 300.

In the illustrated embodiment, the motor assembly 360 includes a motor 446 disposed within the motor housing 362. In addition to the main body 394 and the back cover 396, the motor housing 362 also includes a front cover 448 disposed at an end (e.g., upstream end, shaft end) of the main body 394 opposite the back cover 396. Similar to the back cover 396, the front cover 448 may also be attached to the main body 394 of the motor housing 362 via one or more mechanical fasteners 302 (e.g., screws, nuts and bolts). The main body 394, the back cover 396, and the front cover 448 may cooperatively enclose the motor 446 within the motor housing 362. Further, in some embodiments, the motor 446 may be supported and/or mounted within the motor housing 362 via one or more mounting plates or brackets 450, which may be attached to the motor housing 362 via mechanical fasteners 302.

The motor 446 may be any suitable motor or actuator configured to drive rotation of the fan wheel 342. For example, the motor 446 may be an electromechanical motor, an electric motor, an alternating current motor, a direct current motor, or any other suitable type of motor. As shown, the motor 446 includes a shaft 452 extending through the front cover 448 and into the hub 366. The shaft 452 may be attached (e.g., rotationally fixed) to the hub 366 via a hub bushing 454 and a hub bushing support 456 secured within an aperture 458 of the hub 366 (e.g., the back cover 396 and/or the front cover 448). In this way, the motor 446 may operate to drive rotation of the shaft 452, and rotational motion of the shaft 452 may be imparted to the fan wheel 342, thereby inducing rotation of the fan wheel 342. As the fan wheel 342 rotates, the fan assembly 300 may draw the air flow 338 into the fan assembly 300 via the inlet 336, across the blades 364, across the guide vanes 372, and out of the outer housing 312 via an outlet 460 of the fan assembly 300.

The illustrated embodiment also shows the baffle 370 in an assembled configuration of the fan assembly 300. The baffle 370 is disposed radially between (e.g., relative to the central axis 306) the shroud 368 and the outer housing 312, as discussed above. The baffle 370 is also attached to the outer housing 312 (e.g., an inner surface 462 of the outer housing 312) via mechanical fasteners 302. To this end, the baffle 370 may have any suitable geometry, such as an L-shaped cross-sectional geometry. For example, the baffle 370 may include a first portion 464 configured to extend along the inner surface 462 of the outer housing 312 (e.g., in the circumferential direction 310). The first portion 464 may include one or more apertures configured to receive corresponding mechanical fasteners 302 (e.g., nuts and bolts) to mechanical attach the first portion 464, and therefore the baffle 370, to the inner surface 462. The baffle 370 also includes a second portion 466 extending cross-wise from the first portion 464. In particular, the second portion 466 extends radially inward (e.g., relative to the central axis 306) toward the shroud 368. In this way, the baffle 370 may block recirculation of the air flow 338 within the outer housing 312.

It should be appreciated that any suitable mechanical fastening components may be utilized as the mechanical fasteners 302 to assemble the components discussed above without welding or other fabrication processes. For example, as discussed in detail above, the mechanical fasteners 302 may include rivets 468, nuts 470, bolts 472, washers 474, screws 478, another mechanical fastening component, or any combination thereof to mechanically attach the components discussed above without the using of welding or other time-consuming and expensive fabrication processes. Indeed, it should also be appreciated that the components discussed above that may be assembled via the mechanical fasteners 302 may include corresponding features, such as openings, apertures, recesses, slots, and so forth, to enable extension of mechanical fasteners 302 therethrough and actuation of the mechanical fasteners 302 to facilitate assembly of the components of the fan assembly 300 in the manner described above.

As set forth above, embodiments of the present disclosure may provide one or more technical effects useful for manufacturing and assembling of fan assemblies, such as mixed flow inline fan assemblies, in a more cost effective and efficient manner. In particular, present embodiments are directed to a fan assembly, such as a mixed flow inline fan assembly, that includes various components assembled together with mechanical fasteners, such as nuts and bolts, rivets, screws, and so forth. Indeed, a substantial number of the components of the fan assembly may be assembled to one another via mechanical fasteners. In other words, a substantial number of the components of the fan assembly may not be assembled to one another via welding or other time consuming and expensive fabrication process. As a result, present embodiments provide a fan assembly that may be manufactured more quickly and at a reduced cost. In addition to enabling a reduction in manufacturing (e.g., labor) costs, present embodiments also enable a reduction in material costs associated with manufacture of the fan assembly. For example, utilization of mechanical fasteners to assemble a substantial portion of the components of the fan assembly enables the use of more lightweight and cost-effective materials for the components of the fan assembly. Accordingly, the fan assemblies disclosed herein may be transported and installed with greater ease and efficiency.

While only certain features and embodiments have been illustrated and described, many modifications and changes may occur to those skilled in the art, such as variations in sizes, dimensions, structures, shapes and proportions of the various elements, values of parameters, such as temperatures and pressures, mounting arrangements, use of materials, colors, orientations, and so forth, without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure.

Furthermore, in an effort to provide a concise description of the exemplary embodiments, all features of an actual implementation may not have been described, such as those unrelated to the presently contemplated best mode, or those unrelated to enablement. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A mixed flow inline fan assembly, comprising:
an outer housing;
a motor assembly disposed within the outer housing; and
a fan wheel disposed within the outer housing, wherein a shaft of the motor assembly is coupled to the fan wheel, and the fan wheel comprises:
a hub;
a plurality of blades coupled to the hub via first mechanical fasteners; and
a shroud coupled to the plurality of blades via second mechanical fasteners.

2. The mixed flow inline fan assembly of claim 1, wherein the first mechanical fasteners, the second mechanical fasteners, or both comprise rivets.

3. The mixed flow inline fan assembly of claim 1, wherein the motor assembly comprises a motor housing, and the mixed flow inline fan assembly comprises a plurality of guide vanes extending from the outer housing to the motor housing, and each guide vane of the plurality of guide vanes is attached to the outer housing and to the motor housing via additional mechanical fasteners.

4. The mixed flow inline fan assembly claim 3, wherein the plurality of guide vanes comprises first guide vanes arrayed circumferentially about the motor housing and second guide vanes arrayed circumferentially about the motor housing, wherein the first guide vanes are disposed within the outer housing upstream of the second guide vanes relative to a direction of air flow through the outer housing.

5. The mixed flow inline fan assembly of claim 4, wherein each first guide vane comprises a first guide surface having a curved geometry, and each second guide vane comprises a second guide surface having a planar geometry.

6. The mixed flow inline fan assembly of claim 1, comprising a baffle disposed within the outer housing, wherein the baffle comprises:
a first portion attached to an inner surface of the outer housing via additional mechanical fasteners; and
a second portion extending from the first portion and extending radially toward the shroud relative to a central axis of the mixed flow inline fan assembly.

7. The mixed flow inline fan assembly of claim 6, wherein the baffle extends circumferentially about the shroud.

8. The mixed flow inline fan assembly of claim 1, comprising an inlet body coupled to the outer housing, wherein the inlet body defines an air flow inlet of the mixed flow inline fan assembly, and the inlet body is coupled to the outer housing via additional mechanical fasteners.

9. The mixed flow inline fan assembly of claim 8, wherein the inlet body comprises a venturi surface defining the air flow inlet.

10. The mixed flow inline fan assembly of claim 1, comprising a plurality of lifting lugs attached to the outer housing, wherein each lifting lug of the plurality of lifting lugs is attached to the outer housing via respective additional mechanical fasteners.

11. A mixed flow inline fan assembly, comprising:
an outer housing;
an inlet body coupled to the outer housing via first mechanical fasteners, wherein the inlet body is configured to direct an air flow into the outer housing, and wherein the inlet body is coupled to the outer housing via first mechanical fasteners;
a motor disposed within the outer housing, wherein the motor comprises a shaft; and
a fan wheel disposed within the outer housing and coupled to the shaft, wherein the fan wheel comprises a hub, a plurality of blades coupled to the hub and extending radially outward from the hub, and a shroud coupled to the plurality of blades and extending circumferentially about the plurality of blades, wherein the hub, the plurality of blades, and the shroud are assembled together via second mechanical fasteners.

12. The mixed flow inline fan assembly of claim 11, wherein the first mechanical fasteners comprise nuts and bolts.

13. The mixed flow inline fan assembly of claim 12, wherein the second mechanical fasteners comprise rivets.

14. The mixed flow inline fan assembly of claim 11, comprising:
a first outer mounting ring mounted to an outer surface of the outer housing via a first subset of the first mechanical fasteners; and
an inlet body mounting ring mounted to the first outer mounting ring via a second subset of the first mechanical fasteners,
wherein the inlet body is mounted to the inlet body mounting ring via a third subset of the first mechanical fasteners.

15. The mixed flow inline fan assembly of claim 11, comprising a plurality of guide vanes extending from the outer housing to a motor housing of the motor, wherein the plurality of guide vanes is disposed downstream of the fan wheel relative to a direction of the air flow through the outer housing, and wherein each guide vane of the plurality of guide vanes is attached to the outer housing and to the motor housing via additional mechanical fasteners.

16. The mixed flow inline fan assembly of claim 15, wherein the additional mechanical fasteners comprise nuts and bolts.

17. The mixed flow inline fan assembly of claim 11, comprising a baffle coupled to an inner surface of the outer housing via additional mechanical fasteners, wherein the baffle extends circumferentially about the fan wheel, and the baffle extends radially inward toward the shroud relative to a central axis of the mixed flow inline fan assembly.

18. A mixed flow inline fan assembly, comprising:
an outer housing;
an inlet body coupled to the outer housing, wherein the inlet body is configured to direct an air flow into the outer housing;
a motor assembly disposed within the outer housing, wherein the motor assembly comprises a motor housing and a motor disposed within the motor housing; and
a fan wheel disposed within the outer housing and coupled to the motor, wherein the fan wheel comprises a hub, a plurality of blades coupled to the hub, and a shroud coupled to the plurality of blades and extending circumferentially about the plurality of blades,
wherein the outer housing, the inlet body, the motor assembly, the hub, the plurality of blades, and the shroud are coupled to one another via mechanical fasteners.

19. The mixed flow inline fan assembly of claim 18, comprising a plurality of guide vanes extending from the outer housing to the motor housing, wherein the plurality of guide vanes is disposed downstream of the fan wheel relative to a direction of the air flow through the outer housing, and wherein the plurality of guide vanes is attached to the outer housing and to the motor housing via additional mechanical fasteners.

20. The mixed flow inline fan assembly of claim 19, wherein the mechanical fasteners and the additional mechanical fasteners comprise nuts and bolts, rivets, or a combination thereof.
